(19) United States
(12) Patent Application Publication
(10) Pub. No.: US 2007/0211040 A1
(43) Pub. Date: Sep. 13, 2007

(54) Item selection methods

(75) Inventors: John C. Wang, Taoyuan (TW); Hsi-Kun Chen, Taoyuan (TW); Te-Chuan Liu, Taoyuan (TW); Yi-Shen Wang, Taoyuan (TW); Hsing-Chiang Huang, Taoyuan (TW); Ming-San Huang, Taoyuan (TW)

Correspondence Address: BIRCH STEWART KOLASCH & BIRCH, PO BOX 747, FALLS CHURCH, VA, 22040-0747, US

(73) Assignee: HIGH TECH COMPUTER, CORP.

(21) Appl. No.: 11/641,736

(22) Filed: Dec. 20, 2006

(30) Foreign Application Priority Data
Mar. 8, 2006 (TW) 95107892

(51) Int. Cl. G06F 3/041

(52) U.S. Cl. 345/173

(57) ABSTRACT

Item selection methods. Users touch, drag, and release contact along a touch-sensitive mechanism to select software hotkeys or menu items on a display screen. As soon as contact is made with and remains on the surface of the sensor, a menu appears on the display screen. Sustained contact and dragging along the touch-sensitive mechanism moves or scrolls through content items. When contact is terminated with the touch-sensitive mechanism, the highlighted content item is selected for launching.

### BACKGROUND OF THE INVENTION

1. Field of the Invention

The disclosure relates generally to item selection methods, and, more particularly to item selection methods using a touch-sensitive mechanism.

2. Description of the Related Art

When portable devices, particularly handheld devices such as PDAs, smart phones, and mobile phones first emerged on the market, most units were simple to operate, had relatively few controls, and were used primarily for making phone calls.

Recently, handheld devices have become more and more advanced, with built-in cameras, global positioning devices, and Internet access. This advanced functionality creates a dilemma for manufacturers. On one hand, users prefer simple design layouts. On the other hand, they desire customized controls for most programs/applications. Reducing the number of controls on a device to simplify appearance increases complexity of user menus. Frequent moves among menus user increases inconvenience for users.

Therefore, many manufacturers have opted to place more “hotkeys” on handheld devices. FIGS. 1A and 1B respectively show the front and side of a handheld device. As shown in figures, hotkeys H1, H2, H3 and H4 are respectively disposed on the front and side of a handheld device 100. These controls provide instant access to favorite programs and applications. However, when a handheld device becomes “overloaded” with hotkeys, surfaces of the device may become cluttered, and such a layout may lose favor with users who prefer simple designs. Furthermore, since space is limited on most devices, there are constraints on the number of hotkeys that can be placed on any given surface. Manufacturers normally choose the specific hotkeys for new models, but the choices often do not reflect individual user needs.

### BRIEF SUMMARY OF THE INVENTION

Item selection methods are provided.

In an embodiment of an item selection method, a contact on a touch-sensitive mechanism is detected. In response to the contact, a first item is selected from a sequence of items. It is determined whether the contact on the touch-sensitive mechanism remains. If the contact remains and moves along a direction, a second item is re-selected from the items according to the direction. If the contact terminates, the selected item is launched.

In an embodiment of an item selection method for use in a portable device comprising a touch-sensitive mechanism and a display unit, a contact on a touch-sensitive mechanism is detected. In response to the contact, a sequence of items is displayed in the display unit. A first item is selected from the items, and highlighted in a specific area of the display unit. The display unit displays part or all of the items. If the contact remains and moves along a direction, the sequence of the items moves according to the direction, thus a second item within the items is displayed in the specific area of the display unit, and re-selected. If the contact terminates, the selected item is launched.

In an embodiment of an item selection method for use in a portable device comprising a touch-sensitive mechanism and a display unit, a contact on a touch-sensitive mechanism is detected. In response to the contact, a sequence of items is displayed in the display unit. A first item is selected from the items, and highlighted in a specific area of the display unit. The display unit displays part or all of the items. If the contact remains and moves along a direction, a second item within the items is moved to from the first item, and re-selected. If the contact terminates, the selected item is launched.

Item selection methods may take the form of program code embodied in a tangible media. When the program code is loaded into and executed by a machine, the device becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1A shows the front of a handheld device;

FIG. 1B shows the side of a handheld device;

FIG. 2A is a schematic diagram illustrating an embodiment of a portable devoice with a touch-sensitive mechanism;

FIG. 2B is a schematic diagram illustrating another embodiment of a portable devoice with a touch-sensitive mechanism;

FIG. 2C is a schematic diagram illustrating still another embodiment of a portable devoice with a touch-sensitive mechanism;

FIG. 3 is a flowchart of an embodiment of an item selection method;

FIGS. 4A and 4B shows an example of an embodiment of item selection;

FIG. 5 is a schematic diagram illustrating an example of list items arranged circularly;

FIG. 6 is a flowchart of an embodiment of an item selection method; and

FIGS. 7A and 7B shows an example of an embodiment of item selection.

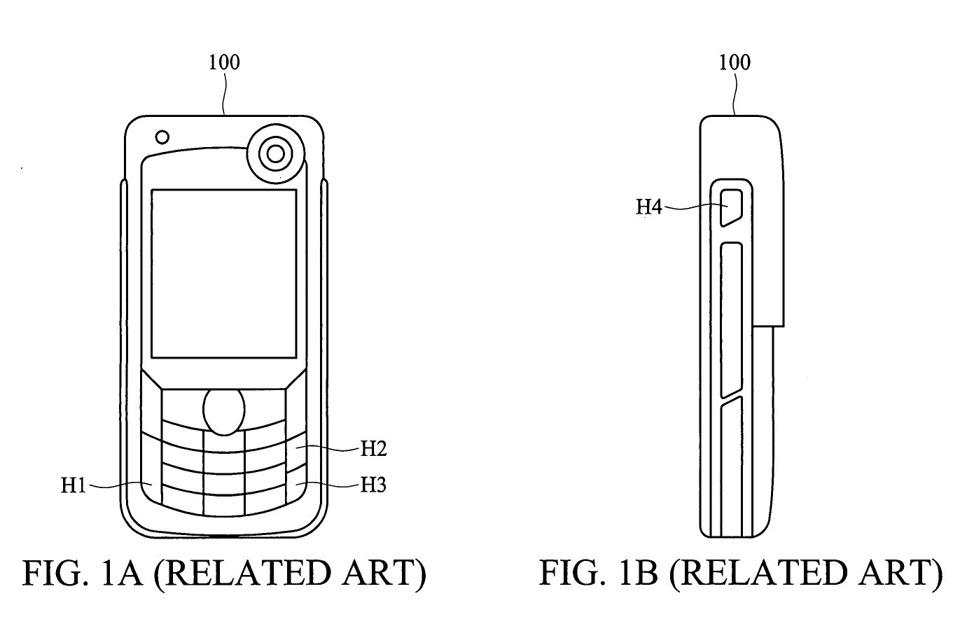

### DETAILED DESCRIPTION OF THE INVENTION

Item selection methods are provided.

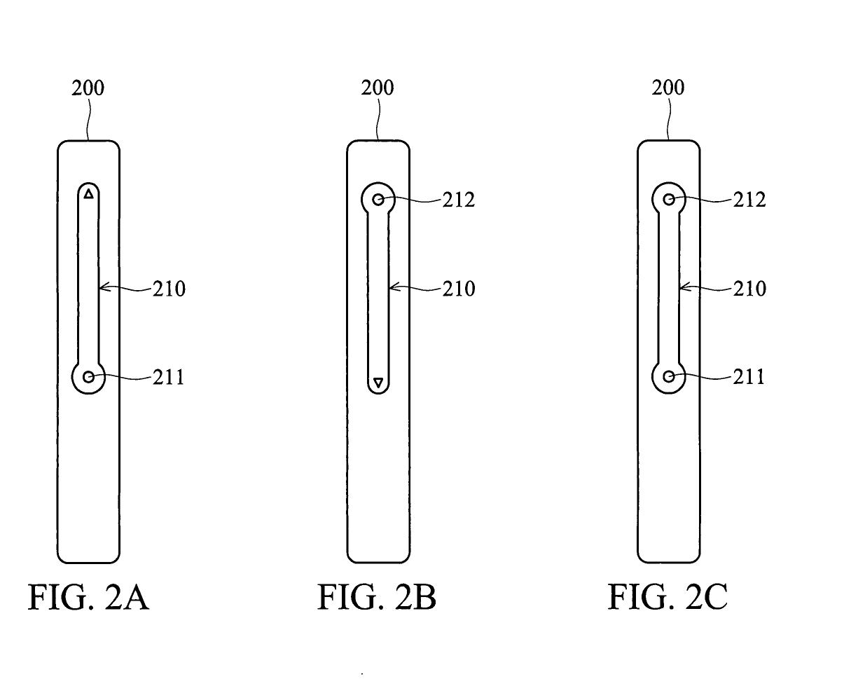

FIGS. 2A, 2B and 2C are schematic diagrams illustrating embodiments of a portable devoice with a touch-sensitive mechanism.

The portable device 200 may be a handheld device such as PDA, smart phone, global positioning device, or mobile phone. The portable device 200 comprises a display unit (not shown), and a touch-sensitive mechanism 210 set on the side thereof. The touch-sensitive mechanism 210 has an elongated touch-sensitive surface, and specific portions 211 and 212 are located in the end regions of the elongated touch-sensitive surface. The differences of FIGS. 2A and 2B is the position of the specific portion, where the specific portion of the touch-sensitive mechanism 210 in FIG. 2A is at the bottom of the elongated touch-sensitive surface, and the specific portion of the touch-sensitive mechanism 210 in FIG. 2B is at the top of the elongated touch-sensitive surface. In some embodiments, two ends of the elongated touch-sensitive surface may have respective specific portions, as shown in FIG. 2C. The functions of the specific portions 211 and 212 are discussed later. It is understood that the touch-sensitive mechanism 210 has at least one one-dimensional sensor, and not limited thereto. The touch-sensitive mechanism may have a multi-dimensional sensor.

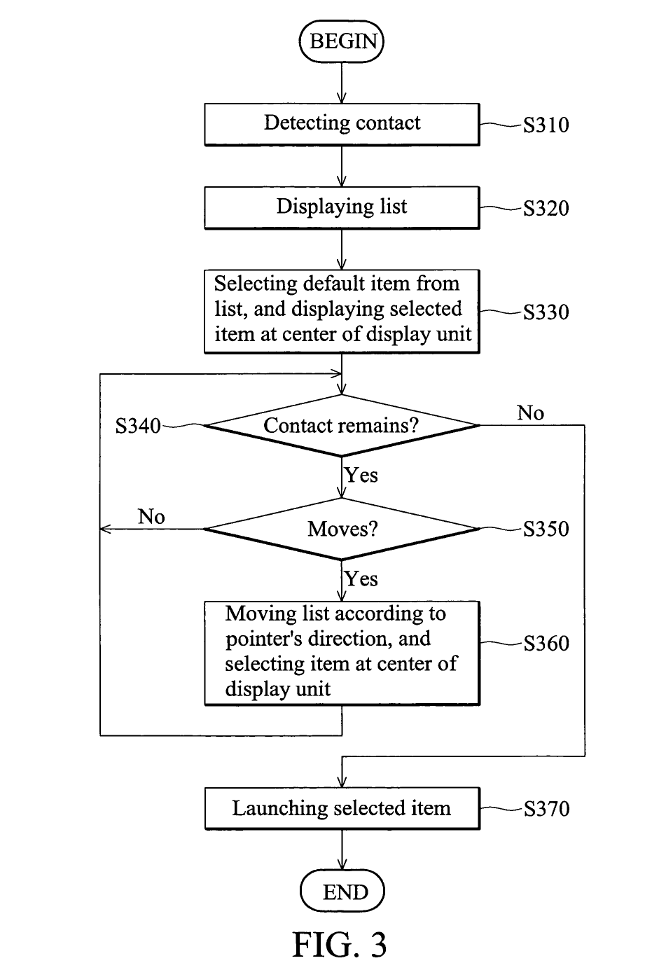

FIG. 3 is a flowchart of an embodiment of an item selection method. In this embodiment, an item list is displayed in the display unit when a finger or stylus contacts the touch-sensitive mechanism, and a selected item is always displayed at the center of the display unit. It is understood that “select” here means an item has been indicated, but not yet activated. As the pointer moves along the touch-sensitive mechanism, items such as hotkey items and labels move according to the direction of the pointer. If the pointer leaves the surface of the touch-sensitive mechanism, the item at the center of the display unit is selected.

In step S310, contact such as a finger or stylus on the touch-sensitive mechanism is detected. In step S320, in response to the contact, a list is displayed in the display unit. The list comprises a sequence of items, and the display unit displays part or all of the items in the list. It is understood that the pointer can make contact with the touch-sensitive mechanism at any position or a specific portion to trigger display of the list. In some embodiments, the specific portion may be one of the end regions of the elongated touch-sensitive surface of the touch-sensitive mechanism, such as the specific portion 211 in FIG. 2A or specific portion 212 in FIG. 2B.

In step S330, a default item is selected from the list items, and the selected item is highlighted at the center of the display unit. It is understood that a schematic diagram of the touch-sensitive mechanism may be also displayed in the display unit, and the contact position of the pointer on the touch-sensitive mechanism can be also marked in the schematic diagram. In step S340, it is determined whether the pointer still contacts the touch-sensitive mechanism. If the contact remains (Yes in step S340) and no move (drag) (No in step S350), the procedure still at step S340. If the contact remains (Yes in step S340) and the pointer moves along a direction (Yes in step S350), in step S360, the list is moved according to the direction of the pointer, thus a specific item within the list items is moved to the center of the display unit, and selected. Thereafter, the procedure returns to step S340. If the pointer stops contacting the touch-sensitive mechanism (No in step S340), in step S370, the selected item is launched.

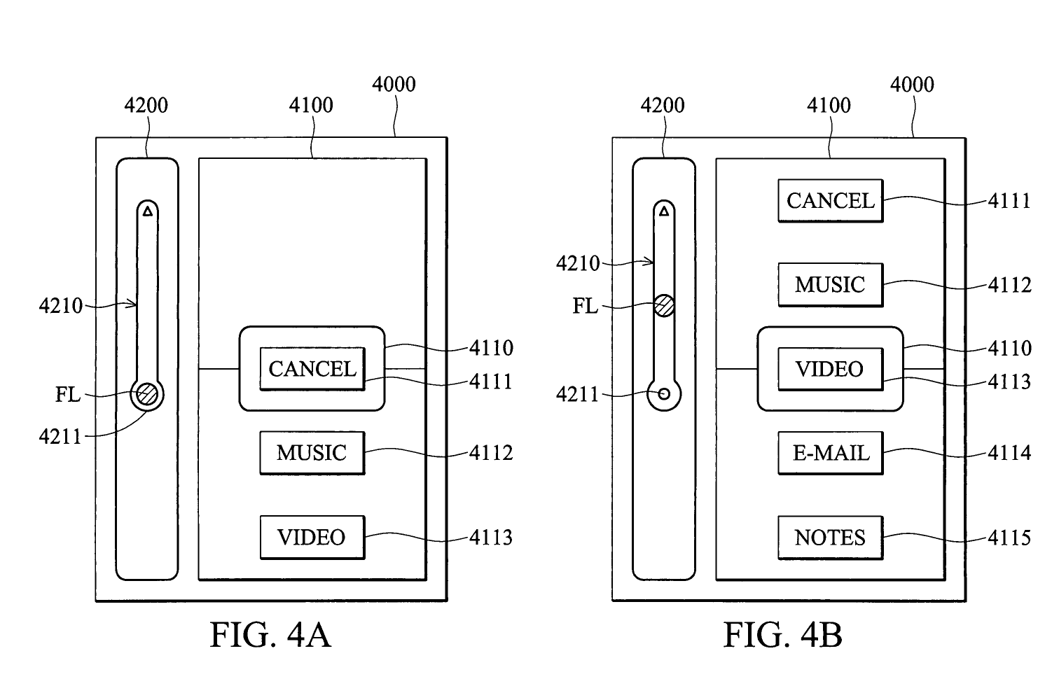

An example follows. If a user wants to play a video recording, he first places the finger at the bottom of the touch-sensitive mechanism. When the finger contacts the touch-sensitive mechanism, a hotkey list is displayed in the display unit, as shown in FIG. 4A. In FIG. 4A, the display unit 4000 comprises an item area 4100 comprising a virtual control area 4110 and an area 4200. The item area 4100 displays a list comprising hotkeys “CANCEL” 4111, “MUSIC” 4112 and “VIDEO” 4113, where hotkey “CANCEL” 4111 is the default item and displayed in the virtual control area 4110. The area 4200 displays the schematic diagram of the touch-sensitive mechanism, and the contact position of the finger on the touch-sensitive mechanism is marked in the schematic diagram. As shown in FIG. 4A, contact at the bottom 4211 of the touch-sensitive mechanism 4210 registers position FL of the contact in the area 4200. It is noted that, in this example, contact must be made at the bottom 4211 of the touch-sensitive mechanism 4210 to trigger display of the list in the display unit 4000. However, in some examples, any position of the touch-sensitive mechanism 4210 can trigger display of the list in the display unit 4000.

To select “VIDEO” 4113, contact slides up the touch-sensitive surface, whereby list items are moved through the virtual control area 4110, such that hotkey “VIDEO” 4113 stays in the virtual control area 4110, as shown in FIG. 4B. Termination of contact with the touch-sensitive mechanism allows hotkey “VIDEO” 4113 to be selected and launched.

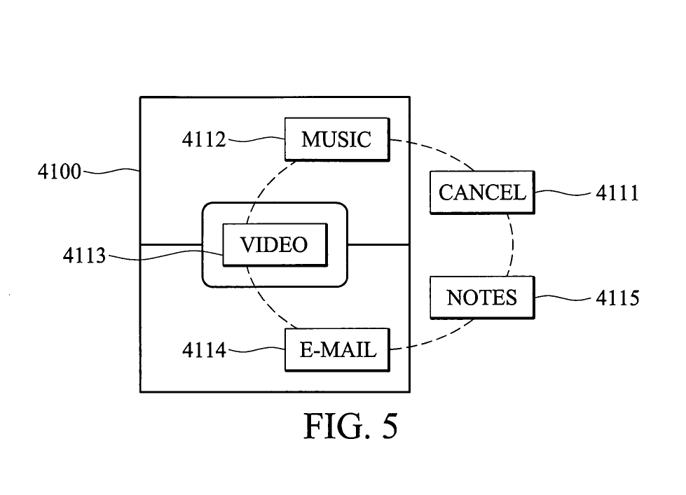

It is understood that since a list may comprise several hotkey items, only part of the hotkey items may be displayed in the item area 4100. With contact movement, other hotkey items such as “E-MAIL” 4114 and “NOTES” 4115 shown in FIG. 4B can be displayed in the item area 4100. Additionally, the hotkey items in the list may be arranged circularly, such that the first and last items are connected, as shown in FIG. 5, where “MUSIC” 4112, “VIDEO” 4113 and “E-MAIL” 4114 are displayed in item area 4100.

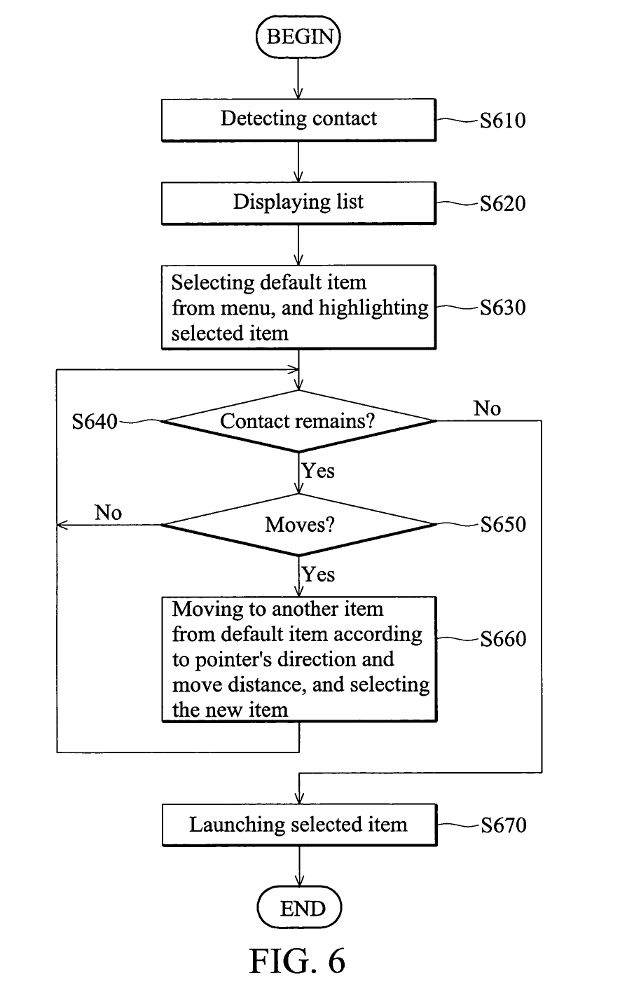

FIG. 6 is a flowchart of an embodiment of an item selection method. In this embodiment, a menu is activated and displayed in the display unit when a pointer contacts the touch-sensitive mechanism, and a default item such as menu item is highlighted. When the contact moves along the touch-sensitive mechanism, the item to be highlighted moves to another item along the direction of the contact. When contact with the surface of the mechanism is terminated, the highlighted item is selected and launched.

In step S610, contact such as a finger or stylus on the touch-sensitive mechanism is detected. In step S620, in response to the contact, a menu is displayed in the display unit. The menu comprises a sequence of items, and the display unit displays part or all of the items in the menu. The pointer can make contact with the touch-sensitive mechanism at any position or a specific portion to trigger display of the menu. In step S630, a default item is selected from the menu items, and the selected item is highlighted in the display unit. Similarly, a schematic diagram of the touch-sensitive mechanism may be also displayed in the display unit, and the contact position of the pointer on the touch-sensitive mechanism can be also marked in the schematic diagram. In step S640, it is determined whether the pointer still contacts the touch-sensitive mechanism. If the contact remains (Yes in step S640) and does not move (No in step S650), the procedure remains at step S640. If the contact remains (Yes in step S640) and contact moves along a direction (Yes in step S650), in step S660, the item to be highlighted is moved from the default item to another item according to the moving distance and direction of the pointer, and selected. Thereafter, the procedure returns to step S640. If the pointer stops contacting the touch-sensitive mechanism (No in step S640), in step S670, the selected item is launched.

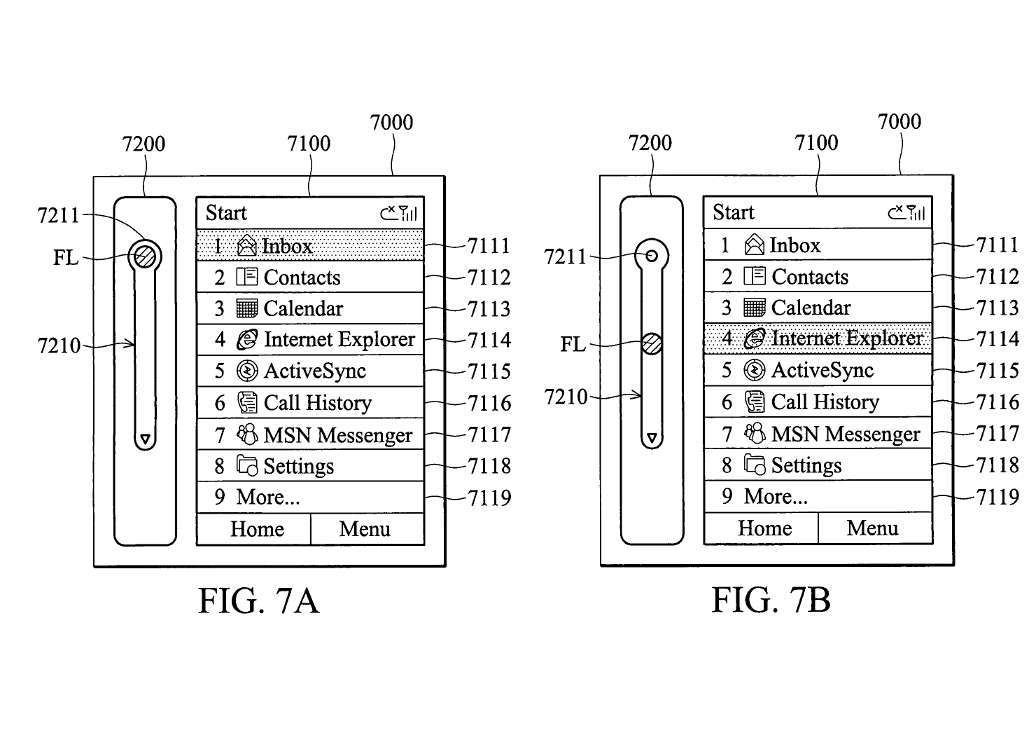

An example follows. To browse the Internet, contact is made at the top of the touch-sensitive surface. Upon contact, a menu is displayed in the display unit, as shown in FIG. 7A. In FIG. 7A, the display unit 7000 comprises an item area 7100 and an area 7200. The item area 7100 displays a menu comprising items “Inbox” 7111, “Contacts” 7112, “Calendar” 7113, “Internet Explorer” 7114, “ActiveSync” 7115, “Call History” 7116, “MSN Messenger” 7117, “Setting” 7118 and “More” 7119, where item “Inbox” 7111 is the default item and highlighted. The area 7200 displays the schematic diagram of the touch-sensitive mechanism 7210, and the contact position on the touch-sensitive mechanism is marked in the schematic diagram. As shown in FIG. 7A, when contact is made at the top 7211 of the touch-sensitive mechanism 7210, the contact position FL is marked in the area 7200. It is noted that, in this example, contact must be made at the top 7211 of the touch-sensitive mechanism 7210 to trigger display of the menu in the display unit 7000. However, in some examples, contact in any position of the touch-sensitive mechanism 7210 can trigger display of the menu in the display unit 7000.

Contact can slide down or up along the surface, with the highlighted item changed accordingly. To browse the Internet, contact slides down along the surface until the cursor lands on the “Internet Explorer” 7114 item, as shown in FIG. 7B. Thereafter, contact is terminated with the touch-sensitive mechanism, whereupon the highlighted item “Internet Explorer” 7114 is selected and launched.

It is understood that the list/menu comprising items is displayed if contact is made in any position or a specific portion of the touch-sensitive mechanism. In some embodiments, however, the list/menu can be displayed in advance, with related operations directly performed upon contact with the touch-sensitive mechanism. Additionally, if two ends of the elongated touch-sensitive surface of the touch-sensitive mechanism are specific portions, one may be dedicated to a function of menu return.

In the invention, contact, drag, and release along a touch-sensitive mechanism with at least one one-dimensional sensor selects and launches specific items such as software hotkeys or menu items. Upon contact with and sustained contact with the surface of the sensor, an item list/menu appears on the display unit. Sliding contact along the touch-sensitive mechanism allows content items to move or scroll to be selected and highlighted. Once contact is terminated with the touch-sensitive mechanism, the highlighted content item is launched. There is no longer a requirement for repeated activation of controls, the touch, drag, and release motion simplifies content selection. Furthermore, since the hotkey and menu items are software implementations, many items can be placed within the device.

Item selection methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the device thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the device becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An item selection method, comprising:
detecting a contact on a touch-sensitive mechanism;
in response to the contact, selecting a first item from a sequence of items;
determining whether the contact on the touch-sensitive mechanism remains;
if the contact remains and moves along a direction, re-selecting a second item from the items according to the direction; and
if the contact terminates, launching the selected item.

2. The method of claim 1 further comprising:
when the contact is detected,
in response to the contact, displaying the sequence of the items in a display unit; and
highlighting the selected first item.

3. The method of claim 1 further comprising:
displaying a schematic diagram of the touch-sensitive mechanism in a display unit; and
marking a contact position corresponding to the contact on the touch-sensitive mechanism in the schematic diagram.

4. The method of claim 1 further comprising moving to the second item within the items from the first item along the direction if the contact remains and moves along the direction.

5. The method of claim 2 further comprising moving the second item to a specific area of the display unit if the contact remains and moves along the direction.

6. The method of claim 1 further comprising contacting a specific portion of the touch-sensitive mechanism, wherein the touch-sensitive mechanism comprises an elongated touch-sensitive surface, and the specific portion comprises one of two ends of the elongated touch-sensitive surface.

7. The method of claim 1 wherein the items are arranged circularly.

8. The method of claim 1 further comprising detecting the contact by detecting signals corresponding to contact made with the touch-sensitive mechanism.

9. An item selection method for use in a portable device comprising a touch-sensitive mechanism and a display unit, comprising:
detecting a contact on the touch-sensitive mechanism;
in response to the contact, displaying a sequence of items in the display unit, selecting a first item from the items, and highlighting the first item in a specific area of the display unit, wherein the display unit displays part or all of the items;
if the contact remains and moves along a direction, moving the sequence of the items according to the direction, thus displaying a second item within the items in the specific area of the display unit, and re-selecting the second item; and
if the contact terminates, launching the selected item.

10. The method of claim 9 further comprising:
displaying a schematic diagram of the touch-sensitive mechanism in the display unit; and
marking a contact position corresponding to the contact on the touch-sensitive mechanism in the schematic diagram.

11. The method of claim 9 further comprising contacting a specific portion of the touch-sensitive mechanism, wherein the touch-sensitive mechanism comprises an elongated touch-sensitive surface, and the specific portion comprises one of two ends of the elongated touch-sensitive surface.

12. The method of claim 9 wherein the items are arranged circularly.

13. The method of claim 9 wherein the portable device comprises a PDA, smart phone, global positioning device, or mobile phone.

14. The method of claim 9 further comprising detecting the contact by detecting signals corresponding to contact with the touch-sensitive mechanism.

15. An item selection method for use in a portable device comprising a touch-sensitive mechanism and a display unit, comprising:
detecting a contact on the touch-sensitive mechanism;
in response to the contact, displaying a sequence of items in the display unit, selecting a first item from the items, and highlighting the first item in a specific area of the display unit, wherein the display unit displays part or all of the items;
if the contact remains and moves along a direction, moving to a second item within the items from the first item, and re-selecting the second item; and
if the contact terminates, launching the selected item.

16. The method of claim 15 further comprising:
displaying a schematic diagram of the touch-sensitive mechanism in the display unit; and
marking a contact position corresponding to the contact on the touch-sensitive mechanism in the schematic diagram.

17. The method of claim 15 further comprising contacting a specific portion of the touch-sensitive mechanism, wherein the touch-sensitive mechanism comprises an elongated touch-sensitive surface, and the specific portion comprises one of two ends of the elongated touch-sensitive surface.

18. The method of claim 15 wherein the items are arranged circularly.

19. The method of claim 15 wherein the portable device comprises a PDA, smart phone, global positioning device, or mobile phone.

20. The method of claim 15 further comprising detecting the contact by detecting signals corresponding to contact with the touch-sensitive mechanism.

21. A machine-readable storage medium comprising a computer program, which, when executed, causes a device to perform an item selection method, the method comprising:
detecting a contact on a touch-sensitive mechanism;
in response to the contact, selecting a first item from a sequence of items;
determining whether the contact on the touch-sensitive mechanism remains;
if the contact remains and moves along a direction, re-selecting a second item from the items according to the direction; and
if the contact terminates, launching the selected item.

22. The storage medium of claim 21 wherein the method further comprises detecting the contact by detecting signals corresponding to contact with the touch-sensitive mechanism.

23. A machine-readable storage medium comprising a computer program, which, when executed, causes a device to perform an item selection method, the method comprising:
detecting a contact on the touch-sensitive mechanism;
in response to the contact, displaying a sequence of items in the display unit, selecting a first item from the items, and highlighting the first item in a specific area of the display unit, wherein the display unit displays part or all of the items;
if the contact remains and moves along a direction, moving the sequence of the items according to the direction, thus displaying a second item within the items in the specific area of the display unit, and re-selecting the second item; and
if the contact terminates, launching the selected item.

24. The storage medium of claim 23 wherein the method further comprises detecting the contact by detecting signals corresponding to contact with the touch-sensitive mechanism.

25. A machine-readable storage medium comprising a computer program, which, when executed, causes a device to perform an item selection method, the method comprising:
detecting a contact on the touch-sensitive mechanism;
in response to the contact, displaying a sequence of items in the display unit, selecting a first item from the items, and highlighting the first item in a specific area of the display unit, wherein the display unit displays part or all of the items;
if the contact remains and moves along a direction, moving to a second item within the items from the first item, and re-selecting the second item; and
if the contact terminates, launching the selected item.

26. The storage medium of claim 25 wherein the method further comprises detecting the contact by detecting signals corresponding to contact with the touch-sensitive mechanism.
